(19) United States
(12) Patent Application Publication
(10) Pub. No.: US 2002/0187235 A1
(43) Pub. Date: Dec. 12, 2002

(54) Ingestible laxative beverage

(76) Inventor: Chun Yu, Los Angeles, CA (US)

Correspondence Address: James E. Brunton, Suite 860, P.O. Box 29000, 700 North Brand Blvd., Glendale, CA, 91029, US

(21) Appl. No.: 09/846,710

(22) Filed: Apr. 30, 2001

(51) Int. Cl. A23J 3/00

(52) U.S. Cl. 426/570

(57) ABSTRACT

A non-habit forming and ecologically beneficial laxative in beverage form that exhibits a novel synergistic effect in relieving and preventing both temporary and chronic constipation without pains or hurting the mucous lines in the colon. The primary constituents of the ingestible laxative beverage comprise a water-soluble, low viscosity fiber selected from a group consisting of fractocligosaccharides, maltodextrin and polydextrose and any qualified one and an herbal laxative selected from a group consisting of cascara sagrada and rhubarb extracts. The secondary active constituents of the ingestible beverage laxative are selected from a group consisting of chamomile, aloe vera and licorice extracts.

### BACKGROUND OF THE INVENTION

1. Field of the Invention

The present invention relates generally to ingestible laxative beverages. More particularly, the invention concerns beverages such as coffee and cocoa that have been fortified with water-soluble fiber and an herbal laxative such as cascara sagrada.

1. Discussion of the Prior Art

Constipation, which is defined as the infrequent and difficult passage of stool, is suffered from time to time by both the young and old. To relieve constipation a number of different types of ingestible laxative compositions have been suggested in the past. These compositions include chemical laxative compositions and so called “natural” laxative compositions. Exemplary of the so called “natural” laxative compositions is a composition disclosed in U.S. Pat. No. 5,516,524 issued to Kais et al. This composition comprises specified amounts of dioctyl sulfosuccinate and bulk fiber. Exemplary of the prior art chemical laxative compositions is a composition sold by Sterling Winthrop, Inc. of New York, N.Y. under the name and style “Phillips”. The active constituents in this product comprise phenolphthalein and docusate sodium.

By way of background, the frequency of bowel movements among healthy people varies greatly, ranging from three movements a day to three a week. As a rule, if more than three days pass without a bowel movement, the intestinal contents may harden, and a person may have difficulty or even pain during elimination.

Most patients who develop colon cancer, diverticulosis, diverticulitis, hemorrhoids, fistula and fissure have had a lifelong history of difficulty with their bowels. Under normal circumstances, the colon gradually removes the remaining water, and forms a shaped stool that moves toward the rectum as a result of gentle pressure waves. As a general rule, people who eat too little fiber-containing foods tend to experience small hard, dry stools. While a soft, bulky stool can move easily through the colon, the hard, dry stool sticks to the wall of the colon and requires that the colon develop high-pressure waves to move the stool along. In time, the colon is no longer capable of generating such high-pressure waves and requires assistance to push the stool along and the abdominal muscles begin to contribute the necessary force. This straining by the abdominal muscles produces pressure on the entire abdominal wall, sometimes causing hernias, varicose veins, diverticulitis, diverticulosis, hemorrhoids, anal fissures and fistulae. Colorectal cancers also appear to be more common in patients having serious constipation problems, probably due to the concentrated exposure of carcinogens to the colonic surface.

A common cause of chronic constipation is a lack of adequate dietary fiber. Dietary fiber is generally obtained from plant foods, and consists of that portion of the plant that is not digested by man. While the sugars, starches and vitamins are broken down into nutrients and are absorbed by the intestines, the dietary fiber is not digested and go on to form an important component of the stool, the bulk or roughage.

Diet and dietary habits can play a significant role in developing constipation. For example, a lack of interest in eating, which is a problem common to many single or widowed older people, may lead to heavy consumption of convenience foods, which tend to be low in fiber. In addition, loss of teeth may force older people to choose soft, processed foods, which also tend to be low in fiber. A diet high in animal fats (meats, dairy products, eggs) and refined sugar (rich desserts and other sweets), but low in fiber also contributes to constipation as do certain medications that contain aluminum, antispasmodic drugs. Antidepressant drugs, tranquilizers, iron supplements and anti-convulsants for epilepsy can also contribute to constipation.

Astoundingly, records show that every year, Americans spend $725 million on laxatives, many of which are harmful. People who habitually take laxatives frequently become dependent upon them and may require ever increasing dosages until, finally, the intestine becomes insensitive and fails to work properly.

The chemical laxatives should be used with great caution even when used sparingly and in an emergency. Once hurt, it will often require weeks, maybe months, before it is recovered because the bowel's function for elimination is very delicate and easily disturbed.

The substances of the chemical laxatives are essentially poisons and irritants so that it can evacuate the colon. The poisoned colon will evacuate the offending substances as quickly as possible, and pushes everything out including not only the compacted feces but also the healthy friendly bacteria and water. They don't make any contribution of restoring normal bowel function or healthy natural process of defecation but just cause the diarrhea.

These harsh, poisonous substances are absorbed through the lymph and blood vessels and positioned in all parts of the body. Dependency upon laxative compounds will, in time, permanently destroy the normal ability of the bowel to eliminate naturally on its own accord.

The repeated use of those chemical laxatives will cause the necessity to have to increase the number of use and the amount of those laxatives. Use over a long period of time will cause the constipation to be aggravated.

Even so-called natural herbal laxatives, Senna consisting of sennosides A and B is very easily found and purchased everywhere in the USA; its side effects are not really different from the chemical laxatives that causes hurting the mucous lines, gripping, habitual forming, causing diarrhea and losing the beneficial bacteria and water. It just destroys the ecological surrounds in the bowel even if it may have a very rapid effect to relieve the most obstinate constipation just like the chemical laxatives. Those undesired side effects of Senna, the natural herb, have had many countries like China, Korea and many European countries regulate and/or prohibit the use of it.

The thrust of the present invention is directed to the solution of the serious problems set forth in the preceding paragraphs. In this regard, and as will be better understood from the discussion that follows, the principal constituents of the novel ingestible laxative beverage of the present invention include coffee, a soluble fiber, and a highly effective herbal laxative such as cascara sagrada. The coffee component of the present invention not only adds taste and flavor to the beverage, but also functions as an active ingredient. More particularly, the coffee, among other things, helps bile acid secretion which promotes peristalsis movement of the colon. The soluble fiber constituents of the beverage selectively feeds and encourages the growth of beneficial bacteria such as bifidobacterium and also reduces the growth of unfriendly bacteria and the putrefactive substances they produce in the digestive tract. Uniquely, the important cascara sagrada constituent not only alleviates constipation but prevents it as well.

### Vicious Cycle of Constipation

The vicious cycle of constipation is made for the following reasons.

1. Due to the deficiency of the dietary fiber in the daily diet, the bacteria cannot ferment the food waste properly, adequate acid degree (ph) cannot be obtained and the bulky and healthy stools cannot be made in the colon.

2. A lot of consumption of various kinds of chemical preservatives, coloring agents, food additives and etc. contained mainly in the processed and instant foods will wither and kill the friendly bacteria, which causes the inadequate acid degree. And the healthy and bulky stools cannot be made and the normal peristalsis movement of the bowel will stop.

3. The use of many kinds of medicine especially the antibiotic or penicillin will also kill the beneficial bacteria as well as pathogenic bacteria causing illness, which creates the same problems explained above.

The above three are generally the reasons to cause most constipation. The following three are vicious cycle of the constipation.

4. The stools, which are not bulky or properly fermented with adequate acid degree in the colon or sufficient dietary fiber cannot create the healthy peristaltic movement of the bowel.

5. The water of the food waste is absorbed in the colon after its nutrients are digested and absorbed in the small intestine, but even more water is absorbed in the rectum. The healthy stools discussed above hardened, dry and even less bulky in the rectum for a longer period.

6. The inhealthy stools shall be replaced with the unhealthy, which are hardened, dry or less bulky discourage the desire to go to the bathroom because it is more difficult to evacuated and will stay in the rectum for even longer periods of time. Then, the stool will be even more hardened, drier and less bulky. And so on.

### Good Cycle Required for Prevention Against and Relief of Constipation

The good cycle of constipation is made for the following reasons:

1. Intake of the dietary fiber in the daily diet enables the bacteria to ferment the food waste properly, adequate acid degree (ph) to be obtained and the bulky and healthy stools to be made in the colon.

2. Abstinence from a lot of consumption of various kinds of chemical preservatives, coloring agents, food additives and etc. contained mainly in the processed and instant foods will increase the population of the beneficial bacteria, which create the adequate acid degree in the colon. The healthy and bulky stools can be made and the normal peristalsis movement of the bowel will go on.

3. Prohibition of the abuse of medicines especially the antibiotic or penicillin will also increase the population of the beneficial bacteria because it is easier to evacuate and stays in the rectum for a shorter period.

The above three are generally the reasons to create the good way to cure or prevent constipation. The following three are good cycle required to prevent or relieve the constipation.

4. The stools, which are bulky or properly fermented with adequate acid degree in the colon and sufficient dietary fiber can create the healthy peristaltic movement of the bowel.

5. The water of the food waste is absorbed in the colon after its nutrients are digested and absorbed in the small intestine but even more water is absorbed in the rectum. The healthy stools discussed above cannot be hardened, dry or even less bulky in the rectum for short period.

6. The healthy stools, which are not hardened, dry or less bulky encourage the desire to go to the bathroom because to evacuate and will stay in the rectum for even shorter periods of time. The stools will be even softer and more bulky with more moisture. And so on.

This is the good cycle of healthy bowel movement.

### SUMMARY OF THE INVENTION

It is an object of the present invention to provide a highly and ecologically effective, non-habit forming, natural laxative that is very gentle and one which exhibits a novel synergistic effect in relieving both temporary and chronic constipation.

Another object of the invention is to provide a very safe ingestible laxative in beverage form without any side effects such as hurting mucous lines, gripping pains, ecological damage, as for example, losing water and beneficial bacteria in the colon by having diarrhea, which is usually caused by many other chemical or natural herb (Senna) laxatives.

Another object of the invention is to provide a non-habitual forming ingestible laxative, which promotes the beneficial, ecological condition for healthy bacteria and the colon together not just to relieve but also prevent constipation unlike other chemical or natural herbal laxatives (containing Senna).

More particularly, it is an object of the present invention to provide a satisfying, good tasting laxative of the aforementioned character that is administered in the form of a delicious hot or cold coffee or cocoa drink that is quick and easy to prepare.

Another object of the invention is to provide an ingestible laxative in beverage form, the primary active constituents of which include a soluble fiber and a herbal extract powder laxative selected from a group consisting of cascara sagrada and rhubarb.

Another object of the invention is to provide an ingestible laxative of the character described in the preceding paragraph that includes important secondary active constituents selected from a group consisting of chamomile, aloe vera and licorice.

Another object of the invention is to provide an ingestible laxative in beverage form which is rich in natural fibers comprising various kinds of water soluble, low viscosity fibers such as fractocligosaccharides, maltodextrin and polydextrose, which have almost no odor or taste.

Another object of the invention is to provide a concentrate that can be mixed with water to form a hot or cold beverage, the concentrate comprising either a coffee in dried or powdered form or a cocoa in powdered form plus, a soluble fiber and a cascara sagrada constituent preferably in powdered form.

Another object of the invention is to provide a concentrate of the character described in the preceding paragraph, that further includes a secondary active constituent selected from a group consisting of chamomile, aloe vera and licorice.

Another object of the invention is to provide an ingestible laxative beverage that functions to cut off the vicious cycle of the constipation as heretofore discussed.

Another object of the invention is to provide an ingestible laxative beverage to gain the good cycle required for prevention against and relief of constipation.

### DESCRIPTION OF THE INVENTION

As previously discussed and as illustrated in the examples that follow, the primary active ingredients of the preferred form of the ingestible laxative beverage of the present invention comprise coffee, cascara sagrada and water-soluble low viscosity fiber. The secondary active ingredients of the laxative beverage include licorice, chamomile and aloe vera. The non-functional ingredients of the beverage comprise sweeteners, flavor enhancers, and creamers.

Considering first the primary active ingredients of the beverage, the highly important herbal constituent cascara sagrada, whose Latin name is RHAMNUS PURSHIANA, is derived from a plant that is native to the pacific coast states of the United States and to Canada. The cascara sagrada bark, which is obtained from trees with trunk diameters of about 4 feet or more, is used as raw material for the herbal constituent. The bark is allowed to dry and age for one year before use because the fresh bark has an emetic principle that is destroyed on prolonged storage or by heating. After drying and aging, the raw material is extracted, filtered, concentrated, low temperature dried, ground, sifted and finally packed. The extract powder of cascara sagrada as thusly produced is used in the present invention and is of the finest quality containing approximately 20% HydroxyAnthracene Derivative (HAD) and approximately 80% Cascarosides. The extract powder used in the invention is water soluble and negative with respect to E. Coli and Salmonella as demonstrated by microbiological test.

Experience shows that cascara sagrada is effective as a laxative and exhibits no toxicity at recommended dosages. Because cascara sagrada is rich in hormone-like oil, which promotes the peristaltic action in the lower intestinal tract, it has been shown to be highly effective in treating both, acute and chronic types of constipation. An extremely valuable property of the cascara sagrada constituent is that once it is used, repeated dosages of the herb are not necessary. In other words, the treatment not only alleviates constipation but prevents it as well. The fact that cascara sagrada is not habit forming as are many other many pharmaceutical laxatives, makes it even more valuable in correcting cases of chronic constipation.

Additionally, experience has shown that cascara sagrada actually tones and strengthens the bowels while it helps restore normal function. The chemical compounds found in this unique herb, called A-factors, promote a kind of contraction-relaxation-contraction cycle of the muscles that make up the colon walls. These compounds initiate a type of rhythmic harmony and consistency to what would otherwise be irregular contractions of the lower bowel. By creating this type of muscular activity, proper bowel function can continue even when the herb is discontinued.

The alternate laxative constituent of the laxative beverage of the invention, namely, rhubarb, which has the Latin name Rheum officinale, has been used as a medicine for more than 2,000 years. Its constituents include anthraquinones, tannins and resins. It uniquely functions both as a laxative and as a digestive remedy. Its intrinsically cold character is used for clearing “heat” from the stomach, intestine and liver, which condition is known to cause constipation. Two important compounds in Chinese rhubarb root, called sennosides E and F, act on the bowels in the same manner as do sennosides A and B which occur in another well-known herbal laxative, namely senna. When used in large doses, this unique herb will quickly remedy even the most obstinate form of constipation.

With respect to the fiber constituent of the beverage of the invention, dietary fiber is a carbohydrate that is edible but can't be digested by the human gastrointestinal tract since the body lacks the enzyme necessary to break down the links of food molecules. Although the fiber is a carbohydrate there is no calorie intake because it is not digested. There are two basic types of dietary fibers, namely a water-insoluble fiber and a water-soluble fiber. The water-soluble fibers, which find application in the present invention, can take several forms, but water- soluble low viscosity fibers such as fructooligosaccharides, maltodextrin and polydextrose and any qualified water-soluble, low viscosity fiber have proven beneficial. The ecological health benefits of such fibers are many. For example, such fibers selectively feed and encourage the growth of beneficial bacteria such as bifidobacterium in the gastrointestinal tract. The water-soluble fibers also reduce the growth of unfriendly bacteria and the putrefactive substances they produce in the digestive tract. Additionally, such fibers have been shown to relieve constipation, to stop antibiotic-associated diarrhea and to help diabetic's lower blood sugar levels.

To accomplish better evacuation of very old waste or stool, the stool should contain more moisture for soft passage without difficulty or pain. Many people think that fiber in the stool absorbs water like a sponge and does not lose water even in the rectum, where the stools lose water to becomes firm. If it loses too much water because it has very little fiber to keep water and usually, it stays in the rectum too long. (The fiber that most people think is insoluble fiber, which works like sponge and is also good for colon health). The water-soluble low viscosity fiber contained in this invention increases the population of friendly bacteria as their good nutrient. If one gram per day is taken, it will be six times more population after four weeks. The healthy stools should have at least 30% of dead bacteria body in it. And the dead bacteria in the stool works like sponge, which stops losing water in the rectum. The healthy stools have more volume because of the increased dead body of bacteria and more water absorbed by the dead body of bacteria in the stool. The bigger volume of stool makes people go to the bathroom more frequently. The short stay in the rectum makes stool bigger volume and softer. One serving (cup) of the beverage of the present invention provides an average 1 gram of water-soluble, low viscosity fiber and the consumer will use the product of this invention one, two or three times a day.

The coffee constituent of the laxative beverage of the invention is provided not only for the taste and flavor, but also for its beneficial effect as an active ingredient. It has been demonstrated that coffee assists in bile acid secretion that promotes peristalsis movement of the colon. The coffee used in the formulation of the present invention can be in ground form which requires filtration during the preparation of the laxative beverage or it can be so called “instant” coffee in powdered or dried granules that require only reconstitution with hot or cold water. Additionally, coffee constituent can be ready to drink, can be decaffeinated and it can be flavored or unflavored.

The constituent that is an alternative to coffee is cocoa that imparts a pleasant flavor and taste to the laxative beverage. The cocoa constituent is generally provided in a powdered form that is well known and readily commercially available. Cocoa is very good for people who dislike or cannot consume coffee and has only about one quarter of the caffeine found in coffee.

Considering next the secondary functional ingredients of the compounds of the present invention, these important constituents, that are typically provided in the form of extract powders, include licorice, chamomile and aloe vera. With regard to the licorice constituent, licorice has been used medicinally since at least 5 B.C. and is still listed in the official pharmacopoeia as a “drug” for stomach ulcers. In China, licorice is called the “great detoxifier” and is thought to drive poisons from the system. Its constituents include saponins, glycosides, estrogenic substances, cournarins and flavonoids.

Chamomile, which is another of the secondary functional ingredients, is also known by the Latin name Matricaria Chamollia. This important constituent typically comprises flavonoids, valerianic acid, cournarins, tannins and glycosides. Its effects are anti-inflammatory and anti-spasmodic and it is known to act both as a sedative and as a vomit preventative.

The secondary functional ingredient Aloe Vera has long been used to heal wounds. Its constituents include anthraquinone glycosides, resins and polysaccharides. Its effects are purgative and it can both act as a sedative and an agent for promoting bile flow.

As previously mentioned, an important and unexpected synergistic function of the combined primary and secondary active ingredients described in the preceding paragraphs is the effective promotion of bowel peristalsis without gripping or injury to the mucous lines. This unexpected synergistic effect serves to make the laxative beverage of the invention very valuable in effectively treating both periodic and chromic constipation.

The non-functional ingredients used in the formulations of the present invention include sweeteners, flavor enhancers and creamers. In this regard, the sweetener can comprise any natural or artificial sweetener such as sucrose, fructose, maple syrup (or powder), corn syrup, saccharine, aspartame, isomalt and honey. The flavoring can comprise any natural or artificial, powder or liquid flavor of a character well known in the art. Similarly, the creamer can comprise either a non-dairy creamer or a dairy creamer, such as non-fat, skim, or full fat milk.

The several embodiments of the ingestible laxative beverage of the present invention are further illustrated by the examples which follow:

### EXAMPLE 1

### Laxative Ground Coffee Which Requires Some Type of Filtration

Ground coffee, 24 weight % to 90 weight %;

water-soluable, low viscosity fiber, 9 weight % to 66 weight %; and

cascara sagrada 0.3 weight % to 6.2 weight %.

The herbs identified in the foregoing example are preferably powdered extracts or liquid extracts if the finished product is in liquid form.

### EXAMPLE 2

### Laxative Ground Coffee Which Requires Some Type of Filtration

| | Grams per one |
|---|---|
| Constituent | Cup Serving |
| Ground coffee, | 1-5 grams; |
| water-soluble, low viscosity | 0.5-2 grams; |
| fiber, | |
| cascara sagrada | 0.02-0.1 gram. |

The herbs identified in the foregoing example are preferably powdered extracts or liquid extracts if the finished product is in liquid form.

### EXAMPLE 3

| | Grams per one |
|---|---|
| Constituent | Cup Serving |
| Ground coffee | 1-5 grams; |
| water-soluble, low viscosity | 0.5-2 grams; |
| fiber | |
| rhubarb | 0.02-0.1 gram; |
| | and |
| cascara sagrada | 0.02-0.1 gram |

### Laxative Ground Coffee Which Requires Some Type of Filtration

The herbs identified in the foregoing example are preferably powdered extracts or liquid extracts if the finished product is in liquid form.

### EXAMPLE 4

### Laxative Instant Coffee

Instant coffee, 16 weight % to 85 weight %;

water-soluble, low viscosity fiber, 12 weight % to 49 weight %; and

cascara sagrada, 0.33 weight % to 6.2 weight %.

The herbs identified in the foregoing example are preferably powdered extracts or liquid extracts if the finished product is in liquid form.

### EXAMPLE 5

### Laxative Instant Coffee

| | Grams per one |
|---|---|
| Constituent | Cup Serving |
| Instant coffee | 1-3 grams; |
| water-soluble, low viscosity | 0.5-2 grams; |
| fiber | and |
| cascara sagrada | 0.02-0.1 grams. |

The herbs identified in the foregoing example are preferably powdered extracts or liquid extracts if the finished product is in liquid form.

### EXAMPLE 6

### Ground Coffee With Secondary Constituents

| | Grams per one |
|---|---|
| Constituent | Cup Serving |
| Coffee | 1-5 grams; |
| water-soluble, low viscosity | 0.5-2 grams; |
| fiber, | and |
| cascara sagrada | 0.02-1 |
| licorice extract, | 0.02-1 gram. |

The herbs identified in the foregoing example are preferably powdered extracts or liquid extracts if the finished product is in liquid form.

### EXAMPLE 7

| | Grams per one |
|---|---|
| Constituent | Cup Serving |
| Coffee | 1-5 grams; |
| water soluble, low viscosity | 0.5-2 grams; |
| fiber | |
| cascara sagrada | 0.02-0.1 grams; |
| aloe vera | 0.02-1 gram. |

The herbs identified in the foregoing example are preferably powdered extracts or liquid extracts if the finished product is in liquid form.

### EXAMPLE 8

### Laxative Instant Cappuccino Canned Coffee

| | Grams per one |
|---|---|
| Constituent | Cup Serving |
| Coffee | 2-5 grams |
| water soluble, low viscosity | 1-2 grams |
| fiber | |
| cascara sagrada | 0.02-1.0 gram |
| chamomile | 0.02-1.0 gram |
| creamer | 3-10 grams |
| water | 75-200 grams |

The herbs identified in the foregoing example are preferably powdered extracts or liquid extracts if the finished product is in liquid form.

The embodiments of the invention identified in the aforementioned examples can be packed in bottles, cans, multiple bags or individual bags after all ingredients including the primary, the secondary and non-functional ingredients are properly and homogenously blended together.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An ingestible laxative beverage comprising:
(a) a beverage component selected from a group consisting of coffee and Cocoa;
(b) a soluble fiber intermixed with said beverage component, said soluble fiber selected from a group consisting of fractocligosaccharides, maltodextrin and polydextrose and any qualified water-soluble, low viscosity fiber; and
(c) a laxative component intermixed with said beverage, said laxative component selected from a group consisting of cascara sagrada and rhubarb.

2. A laxative beverage as defined in claim 1, further including chamomile.

3. The laxative beverage as defined in claim 1, further including aloe vera.

4. The laxative beverage as defined in claim 1, further including licorice.

5. The laxative beverage as defined in claim 1, further including a flavor enhancer.

6. The laxative beverage as defined in claim 1, further including a sweetener.

7. The laxative beverage as defined in claim 1, further including a creamer.

8. An ingestible laxative in beverage form comprising:
(a) from about 24 weight % to about 90 weight % coffee;
(b) from about 9 weight % to about 66 weight % soluble fiber; and
(c) from about 0.3 weight % to about 6.2 weight % cascara sagrada.

9. The ingestible laxative as defined in claim 7 in which said soluble fiber is selected from a group consisting of fructooligosaccharides, maltodextrin and polydextrose and any qualified water-soluble low viscosity fiber.

10. The ingestible laxative as defined in claim 8 further including chamomile.

11. The ingestible laxative as defined in claim 8 further including aloe vera.

12. The ingestible laxative as defined in claim 8 further including licorice.

13. An ingestible laxative beverage comprising:
(a) a beverage component selected from a group consisting of coffee and cocoa;
(b) a soluble fiber intermixed with said beverage component, said soluble fiber selected from a group consisting of fractocigosaccharides, maltodextrin and polydextros;
(c) a laxative component intermixed with said beverage, said laxative component selected from a group consisting of cascara sagrada and rhubarb;
(d) a licorice component intermixed with said beverage component;
(e) a flavor enhancer;
(f) a sweetener; and
(g) a creamer.

14. An powered ingestible laxative beverage concentrate comprising:
(a) about 16 weight % to about 85 weight % coffee;
(b) about 12 weight % to about 49 weight % soluble fiber selected from a group consisting of fructooligasaccharides; maltodextrin and polydextrose; and
(c) about 0.33 weight % to about 6.2 weight % cascara sagrada.

15. The ingestible laxative as defined in claim 13 in which said coffee is either spray dried or frozen dried.
